(19) United States
(12) Patent Application Publication
(10) Pub. No.: US 2025/0162495 A1
(43) Pub. Date: May 22, 2025

(54) AUTOMATION OF SIGNALING DEVICES ASSOCIATED WITH THE OPERATION OF A VEHICLE

(71) Applicant: Tesla, Inc., Austin, TX (US)

(72) Inventors: Richard Baverstock, San Jose, CA (US); Kendrick Lau, San Francisco, CA (US); Michael Kessler, Los Gatos, CA (US); Tal Zaitsev, Austin, TX (US)

(21) Appl. No.: 18/840,312

(22) PCT Filed: Feb. 23, 2023
(86) PCT No.: PCT/US2023/013708

§ 371 Date: Aug. 21, 2024

Related U.S. Application Data
(60) Provisional application No. 63/268,568, filed on Feb. 25, 2022.

(51) Int. Cl. B60Q 1/34; B60Q 1/40; G06V 20/56

(52) U.S. Cl. CPC B60Q 1/346; B60Q 1/40; G06V 20/56

(57) ABSTRACT

The present invention relates to the configuration and management of actions associated with the automation of one or more turning indicators associated with the operation of a vehicle. A vehicle includes a signal control component (110) to process a set of inputs associated with the operation of a vehicle to determine whether to automatically instantiate one or more turning indicators on the vehicle based on the determination or characterization of turning events. The signal control component also processes a set of inputs associated with the operation of a vehicle to determine whether to automatically cancel one or more activated turning indicators on the vehicle based on the determination or characterization of events.

### CROSS-REFERENCE TO RELATED APPLICATIONS

This application claims prior to U.S. Provisional Application 63/268,568, entitled “AUTOMATIC OF SIGNALING DEVICES ASSOCIATED WITH THE OPERATION OF A VEHICLE,” filed on Feb. 25, 2022. U.S. Provisional Application 63/268,568 is hereby incorporated by reference in its entirety herein.

### FIELD OF INVENTION

The disclosed technology relates to an automation of signaling devices associated with the operation of a vehicle. More specifically, the disclosed technology relates to a system and methods for configuring and managing actions of vehicle's automation signaling devices associated with the operation of the vehicle.

### BACKGROUND

Generally described, a variety of vehicles, such as electric vehicles, combustion engine vehicles, hybrid vehicles, etc., can be configured with user specific information or configuration information to facilitate operation. Vehicles can often include hardware and software functionality that facilitates location services or can access computing devices that provide location services. For example, a control component on a vehicle may be configured to determine an approximated location of the vehicle utilizing external information sources, such as global positioning system (“GPS”) sources, Wireless Local Area Networks (WLAN) access point information sources, Bluetooth information sources, radio-frequency identification (RFID) sources, and other location information available. Additionally, vehicles may include vision systems that include one or more cameras and processing systems to be able to obtain environmental inputs and attempt to detect objects depicted in the inputted data. Still further, vehicles can also include navigation systems or access navigation components that can generate information related to navigational or directional information provided to vehicle occupants and users.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

One aspect of this disclosure is a system for managing a vehicle signaling device based on processed vehicle inputs. The system includes one or more external computing devices associated with a processor and a memory for executing computer-executable instructions to implement a signal control component. The signal control component is configured to obtain a set of inputs related an operation of the vehicle; identify, from the set of inputs, turning signal indicator thresholds and turning events; conduct, based on the set of inputs and turning signal indicator thresholds and turning events, a test to determine whether the vehicle is within the identified thresholds for the identified events; and in response to determining that the vehicle is within the identified thresholds for the identified events, cause the vehicle signaling device to activate a turn signal indicator corresponding to test results.

In the system, the set of inputs can be obtained from vision sensors and vision systems implemented in the vehicle. The vision sensors and vision systems can be configured to collect information regarding environmental inputs related to the operation of the vehicle.

In the system, the turning signal indicator thresholds can include distance or timing thresholds that define a time window in which the turning signal indicator should be activated. The turning signal indicator thresholds can be varied based on a classification of the turning events.

In the system, the turning events can be identified based on a combination of location and navigation information of the vehicle.

In the system, the turning events can be identified based on a driver's historical information related to driver's driving behavior associated with the turning events.

In the system, the signal control component, in response to determining that the vehicle is not within the identified thresholds for the identified events, can identify an upcoming fork or an upcoming merge based on the set of inputs obtained from a vehicle navigation system.

In the system, the activation of the turn signal indicator can trigger a vehicle hardware to switch to a position to turn on a vehicle turn signal.

In the system, the signal controlling component can be configured to automatically cancel the turning signal indicator by processing the set of inputs related to the operation of the vehicle; determining a vehicle position within a lane, and vehicle's proximity and rate of change to a marked lane border; determining whether the vehicle completed a crossing lane based on the determined vehicle position; and in response to determining that the vehicle completed the crossing lane, canceling the turn signal indicator.

Another aspect of this disclosure is a system for managing a vehicle signaling device by identifying turning signal indicator thresholds and turning events of a vehicle; determining whether the vehicle is within the identified thresholds for the identified events; and in response to determining that the vehicle is within the identified thresholds for the identified events, cause the vehicle signaling device to activate a turn signal indicator. The turning signal indicator thresholds are varied based on a classification of the turning events

In the system, the turning signal indicator thresholds and turning events can be identified from vision sensors and vision systems implemented in the vehicle. The vision sensors and vision systems can be configured to collect information regarding environmental inputs related to the operation of the vehicle.

In the system, the turning signal indicator thresholds can include distance or timing thresholds that define a time window in which the turning signal indicator should be activated.

In the system, the turning events can be identified based on a combination of location and navigation information of the vehicle.

In the system, the turning events are identified based on a driver's historical information related to driver's driving behavior associated with the turning events.

In the system, the system can also manage the vehicle signaling device by, in response to determining that the vehicle is not within the identified thresholds for the identified events, identifying an upcoming fork or an upcoming merge based on set of inputs obtained from a vehicle navigation system.

In the system, the activation of the turn signal indicator can trigger a vehicle hardware to switch to a position to turn on a vehicle turn signal.

In the system, the signal controlling component can automatically cancel the turning signal indicator by processing a set of inputs related to an operation of the vehicle; determining a vehicle position within a lane and vehicle's proximity and rate of change to a marked lane border; determining whether the vehicle completed a crossing lane based on the determined vehicle position; and in response to determining that the vehicle completed the crossing lane, canceling the turn signal indicator.

Another aspect of this disclosure is a computer-implemented method for managing a vehicle signaling device. The method includes obtaining a set of inputs related an operation of the vehicle from vision sensors and vision systems implemented in the vehicle; identifying, from the set of inputs, turning signal indicator thresholds and turning events; conducting, based on the set of inputs and turning signal indicator thresholds and turning events, a test to determine whether the vehicle is within the identified thresholds for the identified events; and in response to determining that the vehicle is within the identified thresholds for the identified events, activating a turn signal indicator corresponding to test results. The vision sensors and vision systems are configured to collect information regarding environmental inputs related to the operation of the vehicle. The turning signal indicator thresholds are varied based on a classification of the turning events.

In the method, the set of inputs can be obtained from vision sensors and vision systems implemented in the vehicle. The vision sensors and vision systems can be configured to collect information regarding environmental inputs related to the operation of the vehicle.

In the method, the turning signal indicator thresholds can include distance or timing thresholds that can define a time window in which the turning signal indicator should be activated.

The method can further include, in response to determining that the vehicle is not within the identified thresholds for the identified events, identifying an upcoming fork or an upcoming merge based on the set of inputs obtained from a vehicle navigation system.

The method can further include processing the set of inputs related to the operation of the vehicle; determining a vehicle position within a lane and vehicle's proximity and rate of change to a marked lane border; determining whether the vehicle completed a crossing lane based on the determined vehicle position, and in response to determining that the vehicle completed the crossing lane, canceling the turn signal indicator.

For purposes of summarizing the disclosure, certain aspects, advantages and novel features of the innovations have been described herein. It is to be understood that not necessarily all such advantages may be achieved in accordance with any particular embodiment. Thus, the innovations may be embodied or carried out in a manner that achieves or optimizes one advantage or group of advantages as taught herein without necessarily achieving other advantages as may be taught or suggested herein.

### BRIEF DESCRIPTION OF THE DRAWINGS

Embodiments of this disclosure will be described, by way of non-limiting examples, with reference to the accompanying drawings.

FIG. 1 illustrates an environment that corresponds to the automatic management of turning signal indicators in accordance with one or more aspects of the present application;

FIG. 2 illustrates an architecture for implementing the signal control component 110 on one or more local resources in accordance with one or more aspects of the present application;

FIG. 3 is a flow diagram of a signal control routine implemented by a signal control component 110 in accordance with one or more aspects of the present application;

FIG. 4 is a flow diagram for determining whether to automatically activate a turning signal indicator; and

FIG. 5 is a flow diagram for determining whether to automatically cancel a turning signal indicator.

### DETAILED DESCRIPTION

Generally described, one or more aspects of the present disclosure relate to the configuration and management of actions associated with automation of one or more signaling devices associated with the operation of a vehicle. By way of illustrative example, aspects of the present application relate to processing a set of inputs associated with the operation of a vehicle to determine whether to automatically instantiate one or more turning indicators on the vehicle based on the determination or characterization of turning events. Such turning events can illustratively correspond to the characterization of events associated or encountered during the operation of the vehicle, including, but not limited to, lane changes, lane mergers, lane splits, turn lanes, and the like.

Other aspects of the present application relate to processing a set of inputs associated with the operation of a vehicle to determine whether to automatically cancel one or more activated turning indicators on the vehicle based on the determination or characterization of events. Such events can illustratively correspond to the characterization of events associated with or encountered during the operation of the vehicle, including, but not limited to, lane changes, lane mergers, lane splits, turn lanes, forks, and the like. The events can also illustratively correspond to the characterization of the vehicle's driving path prediction. For example, if the vehicle's driving path indicates that the vehicle is driving leaning to the left from the center of the driving lanes for a certain amount of time, the event may indicate to automatically initiate the left turn signal. The automated cancellation of the turning indicators can further be based on the determination of whether a turning event has been completed, whether a cancellation should be suppressed, or whether a cancellation has been manually overridden.

Generally, the operation of turning indicators associated with the operation of a vehicle corresponds primarily to the manual operation of a control by a driver/user. For example, vehicles typically include a manual control that facilitates manual activation of left turn indicators and right turn indicators based on the direction of travel of the vehicle. Similarly, cancellation of an activated turn indicator can be accomplished by causing the manual control to travel in the opposite direction required for the activation. In some implementations, the manual control may be physically linked to steering systems, such that a sufficient rotation of the steering wheel (e.g., a degree of rotation required to accomplish a turn) can physically cause the manual control to travel to result in the cancellation of an activated turn indicator. In other implementations, a vehicle may be configured with timing mechanisms/controls that measure an amount of elapsed time from activation of a turn indicator. The timing mechanisms can be configured with threshold times that are approximated to be indicative of a turn indicator that has inadvertently or unintentionally been left activated without an intention of an upcoming actual turning event. After a threshold amount of time has passed, the timing mechanism may cause the manual control to travel to result in the cancellation of an activated turn indicator. Such approaches can be deficient in requiring a driver to activate the manual control by manipulation of the control. Additionally, such approaches are further inefficient in being limited to the cancellation of turning indicators for a specific, finite set of scenarios, such as complete turns or prolonged activation.

As previously described, a vehicle may include a number of sensors, processing components, and input sources that may have one or more functions. For example, navigation systems and location systems may be configured for the generation of navigational or directional information. Vision systems may provide object detection that can assist with semi-automated driving functionality, automated driving functionality, or safety systems. Such systems are not independently capable of providing functionality associated with automated management of turning indicators, including automatic or automated activation of turning signals, automated canceling of activated turning signals, or a combination thereof.

To address at least a portion of the above deficiencies, aspects of the present application correspond to the utilization of a combined set of inputs from sensors or sensing systems, location systems, and navigation systems that are integrated to characterize events for automatic activation of turning signal indicators. Aspects of the present application correspond to the utilization of a combined set of inputs from sensors or sensing systems, location systems, and navigation systems that are integrated to characterize events for automatic or automated cancellation of turning signal indicators. Such determination can further include automatic or automated processing of suppression criteria or manual inputs that may prevent or otherwise override the automatic cancellation of activated turning signals.

Illustratively, a vehicle can include a signal control component 110 that obtains and processes a set of inputs associated with the operation of a vehicle to determine whether to automatically instantiate one or more turning indicators on the vehicle based on the determination or characterization of turning events. Such turning events can illustratively correspond to the characterization of events associated with or encountered during the operation of the vehicle, including, but not limited to, lane changes, lane mergers, lane splits, forks, turn lanes, and the like. More specifically, the signal control component 110 can process inputs from a combination of positioning systems, navigation systems, and vision systems that can be used to provide or characterize inputs that enable characterizations of turning events requiring activation of turn signal indicators. In some embodiments, utilization of only a single system, such as navigation system inputs, would not provide sufficient inputs that would be able to characterize many of the illustrative turning events.

In some embodiments, the signal control component 110 may characterize the illustrative turning events based on the vehicle's driving path prediction by utilizing vehicle data obtained from the combination of positioning systems, navigation systems, and/or vision systems. For example, if the vehicle is driving leaning left or right from the center lane of the driving lanes, the signal control component 110 may process the vehicle driving data obtained from a combination of positioning systems, navigation systems, and/or vision systems to determine whether to automatically instantiate one or more turning indicators. The signal control component 110 may also process the threshold or tolerance of the vehicle data obtained from the combination of positioning systems, navigation systems, and/or vision systems in determining whether to automatically instantiate one or more turning indicators. For example, the signal control component 110 may consider how frequently the vehicle is driving by leaning to the left or right from the center lane or crossing the vehicle's driving lanes. The signal component may also characterize the surrounding environment of the vehicle, such as the position information of objects (e.g., other vehicles) surrounding the vehicle or surrounding road conditions. The characterized information may be further used in determining whether to automatically instantiate one or more turning indicators, such as to validate determined turning events. For example, the signal component, after identifying at least one of the events to automatically instantiate one or more turning indicators, may not enable the one or more turning indicators if the vision system of the vehicle detects objects and characterizes aspects of the detected objects, such as other vehicles with a turning indicator or lack of turning indicator, other vehicle accelerator patterns, detected road hazards, detecting debris, identified traffic revisions, etc. In some embodiments, the vehicle's vision systems may provide the vehicle data, including the vehicle's surrounding environment.

The signal control component 110 can also illustratively process a set of inputs associated with the operation of a vehicle to determine whether to automatically cancel one or more activated turning indicators on the vehicle based on the determination or characterization of events. Such inputs can correspond to steering wheel angle, acceleration controls, speed controls, and the like. The automated cancellation of the turning indicators can further be based on the determination of whether a turning event has been completed, whether a cancellation should be suppressed, or whether a cancellation has been manually overridden. Similar to the description of automatic instantiation of the turn signal indicators, the signal control component 110 can process inputs from a combination of positioning systems, navigation systems, and vision systems for providing inputs that enable characterizations of completed turning events requiring the cancellation of turn signal indicators. In some embodiments, utilization of only a single system, such as navigation system inputs, would not provide sufficient inputs that would be able to characterize many of the illustrative turning events. This aspect of the present application can be further exemplified by suppression or override events that are indicative of anticipated additional turning events requiring continued use of the turning indicator after completion of a completed turning event.

In some embodiments, the signal control component 110 may also control hardware or software components of the vehicle, where the hardware or software components are related to activating or deactivating one or more turning indicators on the vehicle. In these embodiments, when the signal control component 110 automatically instantiates one or more turning indicators on the vehicle, the hardware component related to activating the turning indicators on the vehicle can be switched (e.g., engaged) to the position corresponding to the particular turning indicator. For example, when the signal control component 110 instantiate left turning indicators on the vehicle, the turning indicator lever can be shifted down. In some examples, when the signal control component 110 instantiate left turning indicators on the vehicle, corresponding graphical images corresponding to the activated left turning indicator can be displayed on a display of the vehicle. In some embodiments, when the signal control component 110 cancels (e.g., deactivates) the activated turning indicator, the hardware or software components related to activating or deactivating the turning indicator can be switched back to the turning signal deactivation position or display. Embodiments of the present application can be applied with various turn signal switches or interface configurations, such as the turn signal switch implemented in a lever, button, or computerized interface integrated with various display types, etc. The present application does not limit the implementation of the turn signal switch or interface configured in a vehicle. In some embodiments, the signal control component 110 can be directly or indirectly connected to the vehicle controller configured to control the hardware or software component of the vehicle to activate or deactivate the turning signal. The present application does not limit the configuration of the vehicle controller that controls the vehicle's turning indicator activation or deactivation.

Although the various aspects will be described in accordance with illustrative embodiments and a combination of features, one skilled in the relevant art will appreciate that the examples and combination of features are illustrative in nature and should not be construed as limiting. More specifically, aspects of the present application may be applicable to various types of vehicles, including vehicles with different propulsion systems, such as combination engines, hybrid engines, electric engines, and the like. Still further, aspects of the present application may be applicable with various types of vehicles that can incorporate different types of sensors, sensing systems, navigation systems, or location systems. Accordingly, the illustrative examples should not be construed as limiting. Similarly, aspects of the present application may be combined with or implemented with other types of components that may facilitate the operation of the vehicle, including autonomous driving applications, driver convenience applications, and the like.

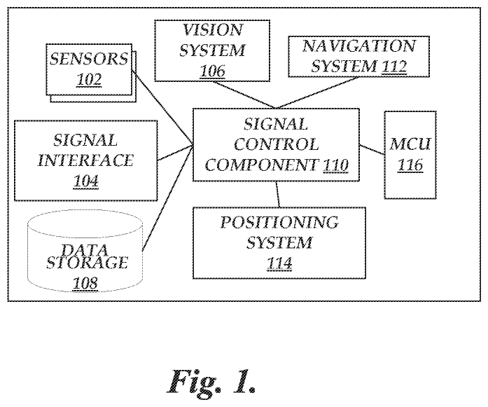

FIG. 1 illustrates an environment that corresponds to the automatic management of turning signal indicators in accordance with one or more aspects of the present application. The environment includes a collection of local sensor inputs that may be utilized to allow a signal control component 110 to automatically instantiate turning signal indicators, automatically cancel turning signal indicators, or a combination thereof. The collection of local sensors 102 can include one or more sensor or sensor-based systems included with a vehicle or otherwise accessible by a vehicle during operation. The local sensors 102 or sensor systems may be integrated into the vehicle. Alternatively, the local sensors 102 or sensor systems may be provided by interfaces associated with a vehicle, such as physical connections, wireless connections, or a combination thereof. Still further, the local sensors 102 or sensor systems can include components that provide an indication of the status or state of aspects of a vehicle operation. Such local sensors 102 or sensor systems can include, but are not limited to, steering wheel or steering control state (e.g., angle of turn), accelerator controls, speed sensors, voice input sensors, and the like.

In one aspect, the local sensors 102 can include vision sensors (e.g., sensors 102) and vision systems 106 that can collect information regarding environmental inputs related to the operation of the vehicle. In one example, the vision sensors 102 and vision systems 106 can identify markers or other identifiers corresponding to driving lanes on a road. In another example, the vision sensors 102 and visions systems 106 can identify markers or other identifiers indicating a current lane of the vehicle as requiring a turn (e.g., a turn lane) or an optional turn. In still another example, the vision sensors and vision systems can identify additional signage or driver guidance information, such as signage, lighting, and the like. The vision sensors and vision system may be configured as part of a vehicle for multiple purposes, including self-driving applications, enhanced driving or user-assisted navigation, and the like. Illustratively, the vision sensors or vision systems can include processing components and data that facilitate the identification of various objects as described herein.

In another aspect, the local sensors 102 can include one or more positioning systems 114 that can obtain reference information from external sources that allow for various levels of accuracy in determining positioning information for a vehicle. For example, the positioning systems can include various hardware and software components for processing information from GPS sources, Wireless Local Area Networks (WLAN) access point information sources, Bluetooth information sources, radio-frequency identification (RFID) sources, and the like. In some embodiments, the positioning systems can obtain combinations of information from multiple sources. Illustratively, the positioning systems can obtain information from various input sources and determine positioning information for a vehicle. In other embodiments, the positioning systems can also determine travel-related operational parameters, such as the direction of travel, velocity, acceleration, and the like. Similar to the vision systems, the positioning system may be configured as part of a vehicle for multiple purposes, including self-driving applications, enhanced driving or user-assisted navigation, and the like. Illustratively, the positioning systems can include processing components and data that facilitate the identification of various vehicle parameters as described herein.

In still another aspect, the local sensors 102 can include one or more navigations system 112 for identifying navigation related information. Illustratively, the navigation systems can obtain positioning information from positioning systems and identify characteristics or information about the identified location. For example, the navigation systems 112 can identify current characteristics of the road, such as anticipated lane mergers, lane splits, turning lanes, etc., based on configured information. The navigation systems 112 can also identify suggested or intended lane locations in a multi-lane road based on directions that are being provided or anticipated for a vehicle user. Similar to the vision systems, the navigation system may be configured as part of a vehicle for multiple purposes, including self-driving applications, enhanced driving or user-assisted navigation, and the like. The navigation systems 112 may be combined or integrated with positioning systems. Illustratively, the positioning systems can include processing components and data that facilitate the identification of various vehicle parameters as described herein.

The local resources further include a signal control component 110 that may be hosted on the vehicle or a computing device accessible by a vehicle (e.g., a mobile computing device). The signal control component 110 can illustratively access inputs from various local sensors 102 and process the inputted data. The signal control component 110 can illustratively process inputs from a combination of positioning systems 114, navigation systems 112, and vision systems 106 to automatically activate turning signal indicators based on characterizations of upcoming turning events. The signal control component 110 can also illustratively process inputs from a combination of positioning systems 114, navigation systems 112, and vision systems 106 to automatically cancel turning signal indicators based on characterizations of completed turning events. Although illustrated and discussed as a singular signal control component 110, in some embodiments, two signal control components 110 can be implemented in a manner to control turning indicator activation and turning signal indicator cancellation independently. The signal control component 110 can access data storage 108 that can maintain sensor information, thresholds or other data required for the implementation of the decision or control algorithms implemented by the control component.

The environment can further include a signal interface 104 component operable to allow the activation and cancellation of turning signal indicators in accordance with various embodiments. Illustratively, the signal control component 110 can transmit commands or other signals that can cause changes to the operational status of the turning signal indicators (e.g., activation or cancellation). In some embodiments, the activation and cancellation of the turning signal indicators can be automated in a manner that does not require operation of a manual control. In embodiments in which a manual control for turning signal indicator operation is available, the signal interface component can provide manipulation information to the control component as inputs to the decision or control algorithms.

In some embodiments, the signal control component 110 can transmit commands or signals corresponding to basic activation or cancellation commands for one or more turning signal activators. In some embodiments, the signal control component 110 transmits the commands or signals to a vehicle controller, such as the microcontroller control unit (MCU) 116 of the vehicle. The MCU 116 can be implemented in the vehicle controller or implemented as a discrete microcontroller. In other embodiments, the signal control component 110 can transmit commands or signal that can include additional supplemental information. For example, the signal control component 110 can transmit information indicative of the type of turning event that was identified. In another example, the signal control component 110 can transmit information indicative of activated display parameters (e.g., intensity, duration, color, etc.) based on the determined turning event. In yet another example, the signal control component 110 can transmit information indicative of cancelled display parameters (e.g., change in intensity, time for cancellation, etc.) based on the determined cancellation event.

In some embodiments, the environment can further include a network service or external device (not shown) that can communicate with one or more of the local sensors or the signal control component 110 via the network connection. The network service/external device can facilitate the processing of local sensor inputs or execution of the decision or control algorithms. The communication network may be any wired network, wireless network, or a combination thereof. In addition, the network may be a personal area network, local area network, wide area network, cable network, fiber network, satellite network, cellular telephone network, data network, or a combination thereof. Protocols and components for communicating via the other aforementioned types of communication networks are well known to those skilled in the art of computer communications and thus, need not be described in more detail herein. The network service is represented in a simplified, logical form and does not reflect all of the physical software and hardware components that may be implemented to provide the functionality associated with the network-based service.

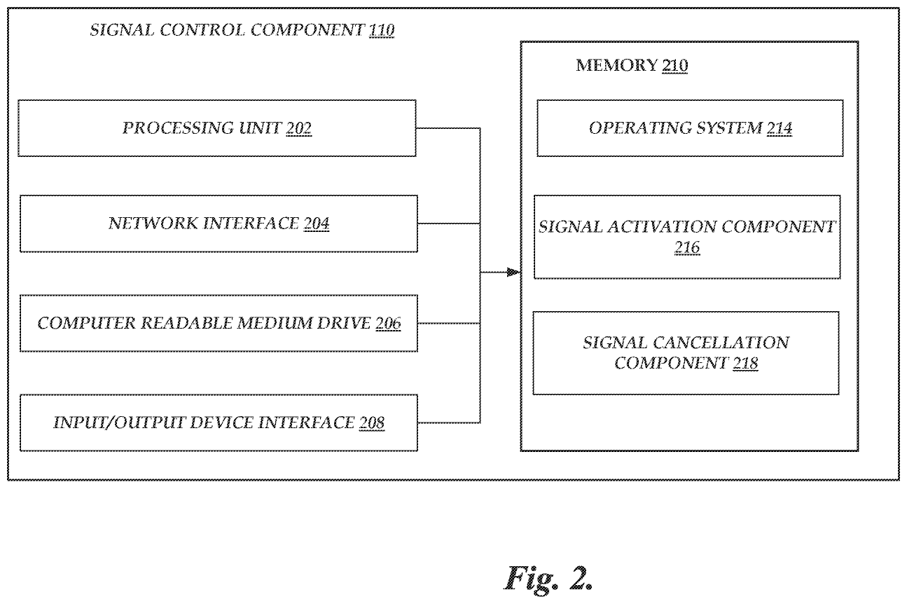

With reference now to FIG. 2, an illustrative architecture for implementing the signal control component 110 on one or more local resources or a network service will be described. The signal control component 110 may be part of components/systems that provide functionality associated with the operation of the turn signal indicators, hazard indicators, etc. In other embodiments, the signal control component 110 may be a stand-alone application that interacts with other components, such as local sensors or sensor systems, signal interfaces, etc.

The architecture of FIG. 2 is illustrative in nature and should not be construed as requiring any specific hardware or software configuration for the signal control component 110. The general architecture of the signal control component 110 depicted in FIG. 2 includes an arrangement of computer hardware and software components that may be used to implement aspects of the present disclosure. As illustrated, the signal control component 110 includes a processing unit 202, a network interface 204, a computer readable medium drive 206, and an input/output device interface 208, all of which may communicate with one another by way of a communication bus. The components of the signal control component 110 may be physical hardware components or implemented in a virtualized environment.

The network interface 204 may provide connectivity to one or more networks or computing systems, network service, or external devices (not shown) that can communicate with one or more of the local sensors 102 or the signal control component 110 via a network connection. The processing unit 202 may thus receive information and instructions from other computing systems or services via a network. The processing unit 202 may also communicate to and from memory and further provide output information for an optional display via the input/output device interface 208. In some embodiments, the signal control component 110 may include more (or fewer) components than those shown in FIG. 2, such as implemented in a mobile device or vehicle.

The memory 210 may include computer program instructions that the processing unit 202 executes in order to implement one or more embodiments. The memory 210 generally includes RAM, ROM, or other persistent or non-transitory memory. The memory 210 may store an operating system 214 that provides computer program instructions for use by the processing unit in the general administration and operation of the signal control component 110. The memory 210 may further include computer program instructions and other information for implementing aspects of the present disclosure. For example, in one embodiment, the memory includes a signal activation component 216 that is configured to receive and process a set of inputs and determine whether to activate turning signal indicators as described herein. The memory 210 further includes a signal cancellation component 218 that is configured to receive and process a set of inputs and determine whether to cancel activated turning signal indicators as described herein.

The signal activation component 216 may obtain and process vehicle operational inputs, such as a combination of navigational, positioning, and vision systems. The signal activation component 216 may obtain the inputs according to various embodiments as disclosed herein. The signal activation component 216 may also obtain turning signal indicator thresholds and trigger events. Illustratively, the turning signal indicator thresholds can include distance or timing thresholds that define a time window in which a turning signal indicator should be activated. For example, based on a determined location (e.g., vehicle ego), one or more thresholds can be defined based on vehicle speed and distance to an identified location. The thresholds illustratively correspond to an established range for activation of the turning signal indicator prior to implementation or the initiation of a turning event. In some embodiments, the thresholds may be defined based on established minimum distance/time thresholds based on vehicle velocity (e.g., a distance or time to target threshold may be larger for higher velocities). Such thresholds may be fixed or established without the ability to modify. In other embodiments, user preferences or user adjustments may be allowed for one or more thresholds.

In still other embodiments, the thresholds may also be varied or dynamically adjusted based on a type or classification of turning event or additional external data. For example, the signal activation component 216 may be configured with different thresholds based on the type of turning event, such as lane changes vs. turning lanes. In other examples, the signal activation component 216 may be configured with different thresholds that can be selected based on external data, such as established traffic levels, weather conditions, geographic location, driver profiles, and the like.

As part of the processing of signal inputs, the signal activation component 216 identifies one or more upcoming turn events based on a combination of location and navigation system information. Such inputs can be based on navigation information based on an inputted destination for the vehicle indicating that a turning event will be required. Such inputs can also be based on historical information indicating that a user is likely to make a turn event based on historical travel information. In other embodiments, the signal activation component 216 can also utilize vision information to identify signage or road indicators (e.g., turning lane signage or indicators) to identify the turn event.

In some embodiments, the signal activation component 216 may conduct a test to determine whether the vehicle (e.g., the vehicle ego) is within one or more of the established thresholds for identified turn event(s). If the signal activation component 216 determines that the vehicle is within a defined threshold for an identified turn event, the signal activation component 216 can cause the activation of the turn signal indicator. Illustratively, if the signal activation component 216 does not determine that the vehicle is within a threshold distance of an identified turn event, the signal activation component 216 may determine whether the vehicle is approaching an upcoming fork in the road. Illustratively, the signal activation component 216 processes inputs from the navigation system that identifies forks in the road. The signal activation component 216 can also determine the possible route of travel for the vehicle based on inputted destination or historical travel information. The signal activation component 216 also can process inputs from the positioning system to determine the proximity of the possible fork in the road within a defined threshold. Still further, the signal activation component 216 can also obtain inputs from the vision systems that identify objects in the road or signage indicative of an upcoming fork, including road signage, lane markers, transmission, and the like. If the signal activation component 216 determines that the vehicle is within a defined threshold for an identified fork, the signal activation component 216 can cause the activation of the turn signal indicator.

Illustratively, if the signal activation component 216 does not determine that the vehicle is within a threshold distance of an identified fork, the signal activation component 216 determines whether the vehicle is approaching an upcoming merge in the road. Illustratively, the signal activation component 216 processes inputs from the navigation system that identifies mergers in the road. The signal activation component 216 can also determine the possible route of travel for the vehicle based on inputted destination or historical travel information. The signal activation component 216 also can process inputs from the positioning system to determine the proximity of the possible fork in the road within a defined threshold. Still further, the signal activation component 216 can also obtain inputs from the vision systems that identify objects in the road (e.g., dotted lines) or signage indicative of an upcoming merger, including road signage, lane markers, transmission, and the like. If the signal activation component 216 determines that the vehicle is within a defined threshold for an identified lane merger, the signal activation component 216 can cause the activation of the turn signal indicator.

If the signal activation component 216 determines that a turn signal indicator should be activated, the signal activation component 216 causes the activation of the signal indicator. As previously described, the signal activation component 216 can transmit commands or signals corresponding to basic activation for one or more turning signal activators. In other embodiments, the signal activation component 216 can transmit commands or signal that can include additional, supplemental information. For example, the signal activation component 216 can transmit information indicative of the type of turning event that was identified. In another example, the signal activation component 216 can transmit information indicative of activated display parameters (e.g., intensity, duration, color, etc.) based on the determined turning event.

The memory 210 further includes the signal cancellation component 218. In some embodiments, the signal cancellation component 218 obtains input according to one or more embodiments as disclosed herein. The signal cancellation component 218 may measure vehicle ego to a detected lane. Illustratively, the signal cancellation component 218 utilizes the set of inputs to determine vehicle position within a lane and the vehicle's proximity and rate of change to the marked lane border.

The signal cancellation component 218 may obtain trigger events (e.g., turning lanes, lane mergers, split/forks, etc.). Such inputs can be based on navigation information based on an inputted destination for the vehicle indicating that a turning event will be required. Such inputs can also be based on historical information indicating that a user is likely to make a turn event based on historical travel information. In other embodiments, the signal cancellation component 218 can also utilize vision information to identify signage or road indicators (e.g., turning lane signage or indicators) to identify the turn event.

In some embodiments, the signal cancellation component 218 may conduct a test to determine whether the vehicle (e.g., the vehicle ego) has completed a crossing event for identified turn event(s). Illustratively, the signal cancellation component 218 can use navigational, positional, or vision information (or various combinations) to determine if the vehicle has crossed the lane marker and completed the turn event for which the turn signal indicator was activated.

If the signal cancellation component 218 determines that the turning event has been completed, the signal cancellation component 218 may measure the vehicle ego to the detected lane. Illustratively, the signal cancellation component 218 can determine whether the turn signal indicator should suppress a cancellation based on the continued progress of the vehicle in the same turn event. For example, a vehicle making two lane change on a highway would require the turn signal indicator to remain activated after the completion of the first lane change. In another example, a vehicle making a lane change into a turn lane would require the turn signal indicator to remain activated after the completion of the lane change into the turning lane. Alternatively, if the measure ego to the detected lane is not indicative of continued progress, the signal cancellation component 218 can determine that a continued lane change is not occurring.

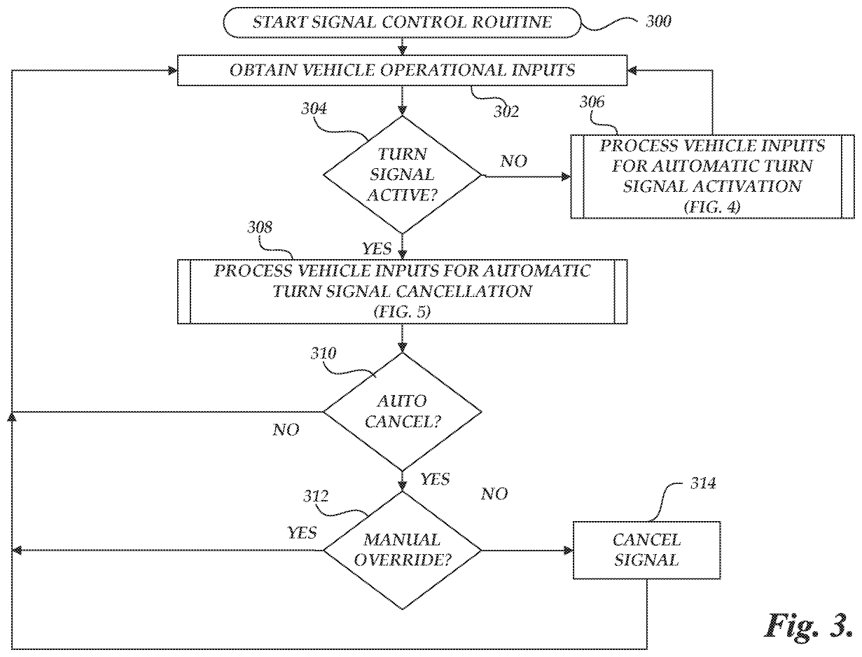

Turning now to FIG. 3, a flow diagram of a signal control routine 300 implemented by a signal control component 110 will be described. Illustratively, signal control routine 300 represents a general routine for incorporating aspects of the automatic activation of turning signal indicators and the automatic cancellation of turning signal indicators. At block 302, the signal control component 110 obtains vehicle operational inputs. As described above, in an illustrative embodiment, the signal control component 110 can process inputs from a combination of navigational, positioning, and vision systems.

In one aspect, inputs can be provided by (or requested by) vision sensors and vision systems that can collect information regarding environmental inputs related to the operation of the vehicle. In one example, the vision sensors and vision systems can identify markers or other identifiers corresponding to driving lanes on the road. In another example, the vision sensors and vision systems can identify markers or other identifiers indicating a current lane of the vehicle as requiring a turn (e.g., a turn lane) or optional turn. In still another example, the vision sensors and vision systems can identify additional signage or driver guidance information, such as signage, lighting, and the like.

In another aspect, inputs can be provided by (or requested from) one or more positioning systems that can obtain reference information from external sources that allow for various levels of accuracy in determining positioning information for a vehicle. For example, the positioning systems can include various hardware and software components for processing information from GPS sources, Wireless Local Area Networks (WLAN) access point information sources, Bluetooth information sources, radio-frequency identification (RFID) sources, and the like. In some embodiments, the positioning systems can obtain combinations of information from multiple sources. Illustratively, the positioning systems can obtain information from various input sources and determine positioning information for a vehicle. In other embodiments, the positioning systems can also determine travel-related operational parameters, such as the direction of travel, velocity, acceleration, and the like.

In still another aspect, inputs can be provided by (or requested by) one or more navigations system for identifying navigation related information. Illustratively, the navigation systems can obtain positioning information from positioning systems and identify characteristics or information about the identified location. For example, the navigation systems can identify current characteristics of the road, such as anticipated lane mergers, lane splits, turning lanes, etc., based on configured information. The navigation systems can also identify suggested or intended lane locations in a multi-lane road based on directions that are being provided or anticipated for a vehicle user.

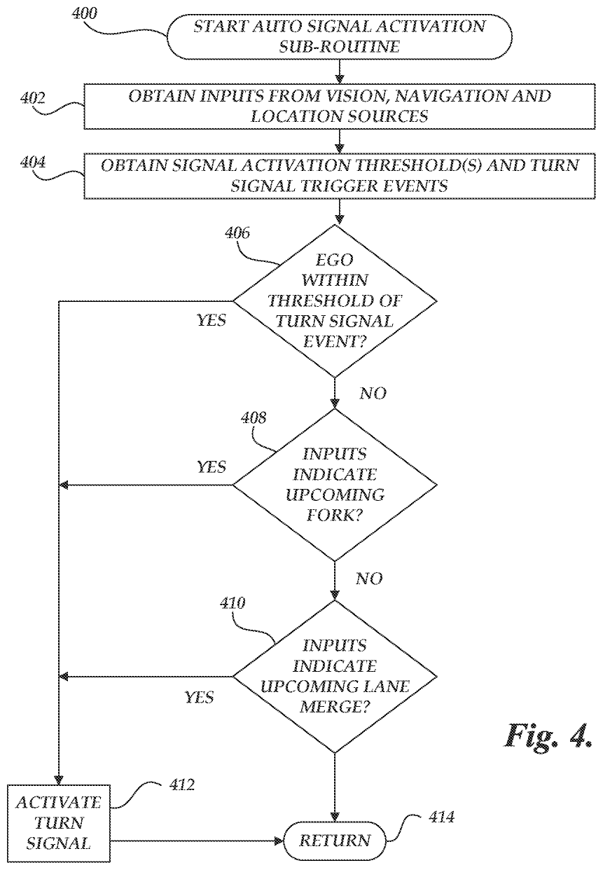

At decision block 304, a test is conducted to determine whether a turning signal indicator is active. If not, it can be assumed that the signal control component 110 will be processing the set of inputs to determine whether to activate a turn signal indicator. At block 306, the signal control component 110 processes the inputs for turn signal indicator activation. An illustrative sub-routine for determining whether to activate a turn signal indicator will be described with regard to FIG. 4. Illustratively, for decision block 304, the signal control component 110 can receive information from the signal interface component that indicates the status of the turn signal indicators (e.g., active or not).

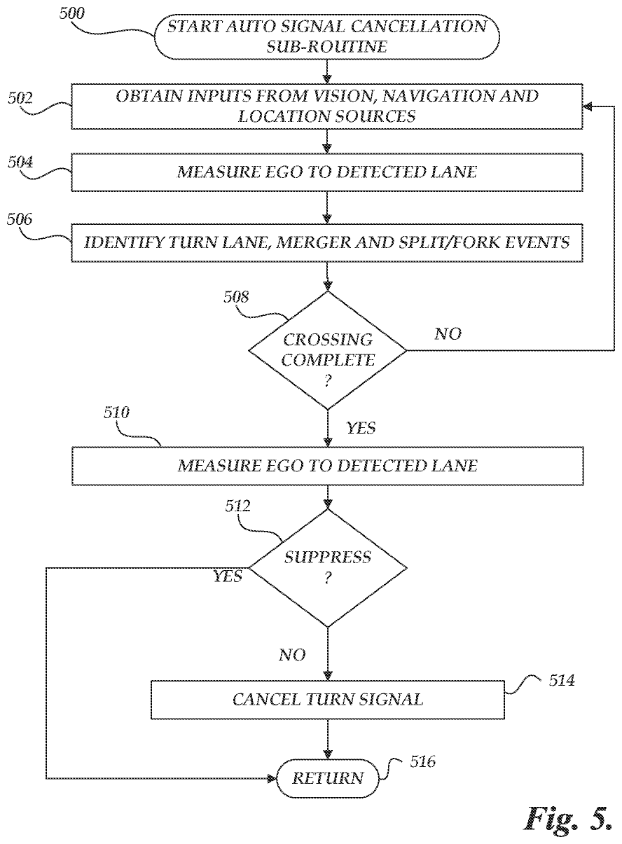

Returning to decision block 304, if a turn signal indicator is active, it can be assumed that the signal control component 110 will be processing the set of inputs to determine whether to cancel an activated turn signal indicator. If so, at block 308, the signal control component 110 processes the inputs for turn signal indicator cancellation. An illustrative sub-routine for determining whether to cancel an activated turn signal indicator will be described with regard to FIG. 5. As described above, for decision block 304, the signal control component 110 can receive information from the signal interface component that indicates the status of the turn signal indicators (e.g., active or not).

At decision block 310, the signal control component 110 determines whether the result of the processing of the set of inputs results in a decision/outcome that results in an automatic cancellation of an activated turn signal. If the result of the processing of the input is not to automatically cancel, the activated turn signal indicator will remain active. Accordingly, routine 300 returns to block 302 to continue collecting and processing inputs to determine whether to automatically cancel the activated turn signal indicator.

If the outcome of processing of the set of inputs corresponds to a decision to automatically cancel an activated turn signal indicator, the routine 300 will further process inputs to determine whether the determination to cancel the activated turn signal indicator should not be implemented. Illustratively, a subsequent decision not to implement a determined cancellation of an activated turn signal indicator can be based on whether a user has manually overridden a cancellation determination. In some embodiments, the user may be provided additional input opportunities in which to cause the turn signal indicator to remain active based on the user's preferences/decisions.

At decision block 312, a test is conducted to determine whether to manually override the cancellation determination. Illustratively, a user may manipulate a manual control to provide an indication of an override, such as depressing an indicator, providing audio inputs, selecting a user interface control, and the like. If a manual override is received, the activated turn signal indicator will remain active. Accordingly, routine 300 returns to block 302 to continue collecting and processing inputs to determine whether to automatically cancel the activated turn signal indicator.

If no manual override indicator is received at block 314, the signal control component 110 causes the turn signal to be canceled. As described above, the signal control component 110 can transmit commands or signals corresponding to basic cancellation commands for one or more turning signal activators. In other embodiments, the signal control component 110 can transmit commands or signal that can include additional supplemental information. For example, signal control component 110 can transmit information indicative of canceled display parameters (e.g., change in intensity, time for cancellation, etc.) based on the determined cancellation event. Thereafter, routine 300 returns to block 302 to continue collecting and processing inputs to determine whether to activate a turn signal indicator.

Turning now to FIG. 4, a sub-routine 400 for determining whether to automatically activate a turning signal indicator will be described. As described above, the signal control component 110 may implement sub-routine 400 as part of block 306 of routine 300 (FIG. 3). At block 402, the signal control component 110 obtains vehicle operational inputs. As described above, in an illustrative embodiment, the signal control component 110 can process inputs from a combination of navigational, positioning, and vision systems.

In one aspect, inputs can be provided by (or requested by) vision sensors and vision systems that can collect information regarding environmental inputs related to the operation of the vehicle. In one example, the vision sensors and vision systems can identify markers or other identifiers corresponding to driving lanes in a road. In another example, the vision sensors and vision systems can identify markers or other identifier indicating a current lane of the vehicle as requiring a turn (e.g., a turn lane) or optional turn. In still another example, the vision sensors and vision systems can identify additional signage or driver guidance information, such as signage, lighting, and the like.

In another aspect, inputs can be provided by (or requested from) one or more positioning systems that can obtain reference information from external sources that allow for various levels of accuracy in determining positioning information for a vehicle. For example, the positioning systems can include various hardware and software components for processing information from GPS sources, Wireless Local Area Networks (WLAN) access point information sources, Bluetooth information sources, radio-frequency identification (RFID) sources, and the like. In some embodiments, the positioning systems can obtain combinations of information from multiple sources. Illustratively, the positioning systems can obtain information from various input sources and determine positioning information for a vehicle. In other embodiments, the positioning systems can also determine travel-related operational parameters, such as the direction of travel, velocity, acceleration, and the like.

In still another aspect, inputs can be provided by (or requested by) one or more navigations system for identifying navigation related information. Illustratively, the navigation systems can obtain positioning information from positioning systems and identify characteristics or information about the identified location. For example, the navigation systems can identify current characteristics of the road, such as anticipated lane mergers, lane splits, turning lanes, etc., based on configured information. The navigation systems can also identify suggested or intended lane locations in a multi-lane road based on directions that are being provided or anticipated for a vehicle user.

Additional inputs from other vehicle operation statuses may also be incorporated, such as manipulation of steering controls, state of vehicle acceleration controls, and the like. Such additional inputs are not required.

At block 404, the signal control component 110 obtains turning signal indicator thresholds and trigger events. Illustratively, the turning signal indicator thresholds can include distance or timing thresholds that define a time window in which a turning signal indicator should be activated. For example, based on a determined location (e.g., vehicle ego), one or more thresholds can be defined based on vehicle speed and distance to an identified location. The thresholds illustratively correspond to an established range for activation of the turning signal indicator prior to implementation or the initiation of a turning event. In some embodiments, the thresholds may be defined based on established minimum distance/time thresholds based on vehicle velocity (e.g., a distance or time to target threshold may be larger for higher velocities). Such thresholds may be fixed or established without the ability to modify. In other embodiments, user preferences or user adjustments may be allowed for one or more thresholds.

In still other embodiments, the thresholds may also be varied based on a type or classification of turning event or additional external data. For example, the signal control component 110 may be configured with different thresholds based on the type of turning event, such as lane changes vs. turning lanes. In other examples, the signal control component 110 may be configured with different thresholds based on external data, such as established traffic levels, weather conditions, and the like.

As part of the processing of signal inputs at block 404, the turn signal component identifies one or more upcoming turn events based on a combination of location and navigation system information. Such inputs can be based on navigation information based on an inputted destination for the vehicle indicating that a turning event will be required. Such inputs can also be based on historical information indicating that a user is likely to make a turn event based on historical travel information. In other embodiments, the turn signal control component 110 can also utilize vision information to identify signage or road indicators (e.g., turning lane signage or indicators) to identify the turn event.

At decision block 406, a test is conducted to determine whether the vehicle (e.g., the vehicle ego) is within one or more of the established thresholds for identified turn event(s). If the signal control component 110 determines that the vehicle is within a defined threshold for an identified turn event, the signal control component 110 can cause the activation of the turn signal indicator at block 412, which will be described below.

Illustratively, if the signal control component 110 does not determine that the vehicle is within a threshold distance of an identified turn event, at decision block 408, the signal control component 110 determines whether the vehicle is approaching an upcoming fork in the road. Illustratively, the signal control component 110 processes inputs from the navigation system that identifies forks in the road. The signal control component 110 can also determine the possible route of travel for the vehicle based on inputted destination or historical travel information. The signal control component 110 also can process inputs from the positioning system to determine the proximity of the possible fork in the road within a defined threshold. Still further, the signal control component 110 can also obtain inputs from the vision systems that identify objects in the road or signage indicative of an upcoming fork, including road signage, lane markers, transmission, and the like. If the signal control component 110 determines that the vehicle is within a defined threshold for an identified fork, the signal control component 110 can cause the activation of the turn signal indicator at block 412, which will be described below.

In some embodiments, the signal control component may characterize the turning events based on the vehicle's driving path prediction by utilizing vehicle data obtained from the combination of positioning systems, navigation systems, and/or vision systems. For example, if the vehicle is driving leaning left or right from the center lane of the driving lanes, the signal control component may process the vehicle driving data obtained from a combination of positioning systems, navigation systems, and/or vision systems to determine whether to automatically instantiate one or more turning indicators. The signal control component may also process the threshold or tolerance of the vehicle data obtained from the combination of positioning systems, navigation systems, and/or vision systems in determining whether to automatically instantiate one or more turning indicators. For example, the signal control component may consider how frequently the vehicle is driving by leaning to the left or right from the center lane or crossing the vehicle's driving lanes.

Illustratively, if the signal control component 110 does not determine that the vehicle is within a threshold distance of an identified fork at decision block 410, the signal control component 110 determines whether the vehicle is approaching an upcoming merge in the road. Illustratively, the signal control component 110 processes inputs from the navigation system that identifies mergers in the road. The signal control component 110 can also determine the possible route of travel for the vehicle based on inputted destination or historical travel information. The signal control component 110 also can process inputs from the positioning system to determine the proximity of the possible fork in the road as within a defined threshold. Still further, the signal control component 110 can also obtain inputs from the vision systems that identify objects in the road (e.g., dotted lines) or signage indicative of an upcoming merger, including road signage, lane markers, transmission, and the like. If the signal control component 110 determines that the vehicle is within a defined threshold for an identified lane merger, the signal control component 110 can cause the activation of the turn signal indicator at block 412, which will be described below.

With reference to decision blocks 406, 408, and 410, if the signal control component 110 determines that a turn signal indicator should be activated, at block 412, the signal control component 110 causes the activation of the signal control component 110 turn signal indicator. As previously described, the signal control component 110 can transmit commands or signals corresponding to basic activation for one or more turning signal activators. In other embodiments, the signal control component 110 can transmit commands or signal that can include additional, supplemental information. For example, the signal control component 110 can transmit information indicative of the type of turning event that was identified. In some embodiments, the signal control component 110 may also control hardware or software components of the vehicle related to activating one or more turning indicators on the vehicle. In these embodiments, when the signal control component 110 causes the activation of the corresponding signal indicator, the hardware component related to activating the turning indicators on the vehicle can be switched (e.g., engaged) to the position corresponding to the particular turning indicator. For example, when the signal control component 110 instantiate left turning indicators on the vehicle, the turning indicator lever can be shifted to down. In some examples, when the signal control component 110 instantiate left turning indicators on the vehicle, corresponding graphical images corresponding to the activated left turning indicator can be displayed on a display of the vehicle. In another example, the signal control component 110 can transmit information indicative of activated display parameters (e.g., intensity, duration, color, etc.) based on the determined turning event. At block 414, the sub-routine 400 returns.

Turning now to FIG. 5, a sub-routine 500 for determining whether to automatically cancel a turning signal indicator will be described. As described above, the signal control component 110 may implement sub-routine 500 as part of block 308 of routine 300 (FIG. 3). At block 402, the signal control component 110 obtains vehicle operational inputs. As described above, in an illustrative embodiment, the signal control component 110 can process inputs from a combination of navigational, positioning and vision systems.

In one aspect, inputs can be provided by (or requested by) vision sensors and vision systems that can collect information regarding environmental inputs related to the operation of the vehicle. In one example, the vision sensors and vision systems can identify markers or other identifiers corresponding to driving lanes on the road. In another example, the vision sensors and visions systems can identify markers or other identifiers indicating a current lane of the vehicle as requiring a turn (e.g., a turn lane) or optional turn. In still another example, the vision sensors and vision systems can identify additional signage or driver guidance information, such as signage, lighting, and the like. Still other inputs can correspond to whether vehicle operational parameters, such as steering wheel or steering control angles, acceleration, speed, etc. may be indicative of or confirm a determined likelihood of a continued or terminated event.

In another aspect, inputs can be provided by (or requested from) one or more positioning systems that can obtain reference information from external sources that allow for various levels of accuracy in determining positioning information for a vehicle. For example, the positioning systems can include various hardware and software components for processing information from GPS sources, Wireless Local Area Networks (WLAN) access point information sources, Bluetooth information sources, radio-frequency identification (RFID) sources, and the like. In some embodiments, the positioning systems can obtain combinations of information from multiple sources. Illustratively, the positioning systems can obtain information from various input sources and determine positioning information for a vehicle. In other embodiments, the positioning systems can also determine travel-related operational parameters, such as the direction of travel, velocity, acceleration, and the like.

In still another aspect, inputs can be provided by (or requested by) one or more navigations system for identifying navigation related information. Illustratively, the navigation systems can obtain positioning information from positioning systems and identify characteristics or information about the identified location. For example, the navigation systems can identify current characteristics of the road, such as anticipated lane mergers, lane splits, turning lanes, etc. based on configured information. The navigation systems can also identify suggested or intended lane locations in a multi-lane road based on directions that are being provided or anticipated for a vehicle user.

At block 504, the signal control component 110 measures vehicle ego to a detected lane. Illustratively, the signal control component 110 utilizes the set of inputs to determine vehicle position within a lane and the vehicle's proximity and rate of change to the marked lane border.

At block 506, the signal control component 110 obtains trigger events (e.g., turning lanes, lane mergers, split/forks, etc.). Such inputs can be based on navigation information based on an inputted destination for the vehicle indicating that a turning event will be required. Such inputs can also be based on historical information indicating that a user is likely to make a turn event based on historical travel information. In other embodiments, the turn signal control component 110 can also utilize vision information to identify signage or road indicators (e.g., turning lane signage or indicators) to identify the turn event.

At decision block 508, a test is conducted to determine whether the vehicle (e.g., the vehicle ego) has completed a crossing event for identified turn event(s). Illustratively, the signal control component 110 can use navigational, positional or vision information (or various combinations) to determine if the vehicle has crossed the lane marker and completed the turn event for which the turn signal indicator was activated. If the signal control component 110 determines that the vehicle has not completed the identified turn event (e.g., a lane change), the sub-routine 500 returns to block 502 to continue monitoring the set of inputs for progress of the turning event.

Alternatively, if the signal control component 110 determines that the turning event has been completed, at block 510, the signal control component 110 measure the vehicle ego to the detected lane. Illustratively, at decision block 512, the signal control component 110 can determine whether the turn signal indicator should suppress a cancellation based on the continue progress of the vehicle in the same turn event. For example, a vehicle making two lane change on a highway would require the turn signal indicator to remain activated after the completion of the first lane change. In another example, a vehicle making a lane change into a turn lane would require the turn signal indicator to remain activated after the completion of the lane change into the turning lane. Other examples may also be included in this decision. Alternatively, if the measure ego to the detected lane is not indicative of continued progress, the signal control component 110 can determine at block 512 that a continue lane change is not occurring.

If the signal control component 110 determines to suppress the cancellation of the activated turn signal indicator (e.g., a continued lane change), the sub-routine 500 returns at block 516 without canceling the activated turn signal indicator. Alternatively, at block 514, the signal control component 110 determines that the activated turn signal indicator should be canceled. In some embodiments, when the signal control component 110 cancels (e.g., deactivates) the activated turning indicator, the hardware or software components related to activating or deactivating the turning indicator can be switched back to the turning signal deactivation position or display. For example, when the signal control component 110 cancels a left turning indicator on the vehicle, the turning indicator lever can be shifted to neutral. In some examples, when the signal control component 110 cancels the left turning indicators on the vehicle, a corresponding graphical image or set of images may be generated to notify of a deactivation of the left turning indicator can be displayed on a display of the vehicle

The processing of the cancel indication was previously described with regard to blocks 310-314 (FIG. 3). Sub-routine 500 returns at block 516.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed decision and control algorithms. It is to be understood that the forms of disclosure herein shown and described are to be taken as representative embodiments. Equivalent elements, materials, processes, or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

1. A system for managing a vehicle signaling device based on processed vehicle inputs, the system comprising one or more external computing devices associated with a processor and a memory for executing computer-executable instructions to implement a signal control component, wherein the signal control component is configured to:
obtain a set of inputs related to an operation of the vehicle;
identify, from the set of inputs, turning signal indicator thresholds and turning events;
conduct, based on the set of inputs and turning signal indicator thresholds and turning events, a test to determine whether the vehicle is within the identified thresholds for the identified events; and
in response to determining that the vehicle is within the identified thresholds for the identified events, cause the vehicle signaling device to activate a turn signal indicator corresponding to test results.

2. The system as recited in claim 1, wherein the set of inputs are obtained from vision sensors and vision systems implemented in the vehicle, wherein the vision sensors and vision systems are configured to collect information regarding environmental inputs related to the operation of the vehicle.

3. The system as recited in claim 1, wherein the turning signal indicator thresholds include distance or timing thresholds that define a time window in which the turning signal indicator should be activated, and wherein the turning signal indicator thresholds are varied based on a classification of the turning events.

4. The system as recited in claim 1, wherein the turning events are identified based on a combination of location and navigation information of the vehicle.

5. The system as recited in claim 1, wherein the turning events are identified based on a driver's historical information related to driver's driving behavior associated with the turning events.

6. The system as recited in claim 1, wherein the signal control component, in response to determining that the vehicle is not within the identified thresholds for the identified events, identifies an upcoming fork or an upcoming merge based on the set of inputs obtained from a vehicle navigation system.

7. The system as recited in claim 1, wherein the activation of the turn signal indicator triggers a vehicle hardware to switch to a position to turn on a vehicle turn signal.

8. The system as recited in claim 1, wherein the signal controlling component further configured to automatically cancel the turning signal indicator comprising:
processing the set of inputs related to the operation of the vehicle;
determining a vehicle position within a lane and vehicle's proximity and rate of change to a marked lane border;
determining whether the vehicle completed a crossing lane based on the determined vehicle position; and
in response to determining that the vehicle completed the crossing lane, canceling the turn signal indicator.

9. A system for managing a vehicle signaling device, the system comprising:
identifying turning signal indicator thresholds and turning events of a vehicle, wherein the turning signal indicator thresholds are varied based on a classification of the turning events;
determining whether the vehicle is within the identified thresholds for the identified events; and
in response to determining that the vehicle is within the identified thresholds for the identified events, causing the vehicle signaling device to activate a turn signal indicator.

10. The system as recited in claim 9, wherein the turning signal indicator thresholds and turning events are identified from vision sensors and vision systems implemented in the vehicle, wherein the vision sensors and vision systems are configured to collect information regarding environmental inputs related to operation of the vehicle.

11. The system as recited in claim 9, wherein the turning signal indicator thresholds include distance or timing thresholds that define a time window in which the turning signal indicator should be activated.

12. The system as recited in claim 9, wherein the turning events are identified based on a combination of location and navigation information of the vehicle.

13. The system as recited in claim 9, wherein the turning events are identified based on a driver's historical information related to driver's driving behavior associated with the turning events.

14. The system as recited in claim 9, wherein the system further comprising, in response to determining that the vehicle is not within the identified thresholds for the identified events, identifying an upcoming fork or an upcoming merge based on a set of inputs obtained from a vehicle navigation system.

15. The system as recited in claim 9, wherein the activation of the turn signal indicator triggers a vehicle hardware to switch to a position to turn on a vehicle turn signal.

16. The system as recited in claim 9, further comprising automatically canceling the turning signal indicator by:
processing a set of inputs related to an operation of the vehicle;
determining a vehicle position within a lane and vehicle's proximity and rate of change to a marked lane border;
determining whether the vehicle completed a crossing lane based on the determined vehicle position; and
in response to determining that the vehicle completed the crossing lane, canceling the turn signal indicator.

17. A computer-implemented method for managing a vehicle signaling device, the method comprising:
obtaining a set of inputs related an operation of the vehicle from vision sensors and vision systems implemented in the vehicle, wherein the vision sensors and vision systems are configured to collect information regarding environmental inputs related to the operation of the vehicle;
identifying, from the set of inputs, turning signal indicator thresholds and turning events, wherein the turning signal indicator thresholds are varied based on a classification of the turning events;
conducting, based on the set of inputs and turning signal indicator thresholds and turning events, a test to determine whether the vehicle is within the identified thresholds for the identified events; and
in response to determining that the vehicle is within the identified thresholds for the identified events, activating a turn signal indicator corresponding to test results.

18. The computer-implemented method of claim 17, wherein the set of inputs are obtained from vision sensors and vision systems implemented in the vehicle, wherein the vision sensors and vision systems are configured to collect information regarding environmental inputs related to the operation of the vehicle.

19. The computer-implemented method of claim 17, wherein the turning signal indicator thresholds include distance or timing thresholds that define a time window in which the turning signal indicator should be activated.

20. The computer-implemented method of claim 17, wherein the method further comprising, in response to determining that the vehicle is not within the identified thresholds for the identified events, identifying an upcoming fork or an upcoming merge based on the set of inputs obtained from a vehicle navigation system.

21. The computer-implemented method of claim 17, wherein the method further comprising:
processing the set of inputs related to the operation of the vehicle;
determining a vehicle position within a lane and vehicle's proximity and rate of change to a marked lane border;
determining whether the vehicle completed a crossing lane based on the determined vehicle position; and
in response to determining that the vehicle completed the crossing lane, canceling the turn signal indicator.
